(19) United States
(12) Patent Application Publication
(10) Pub. No.: US 2020/0065850 A1
(43) Pub. Date: Feb. 27, 2020

(54) INFORMATION PROCESSING METHOD, INFORMATION PROCESSING APPARATUS, AND RECORDING MEDIUM HAVING PROGRAM RECORDED

(71) Applicant: LINE CORPORATION, Tokyo (JP)

(72) Inventors: Shouji FUJIWARA, Tokyo (JP); Masaki KUNIKYO, Tokyo (JP); Kazuki MATSUDA, Tokyo (JP)

(73) Assignee: LINE CORPORATION, Tokyo (JP)

(21) Appl. No.: 16/667,313

(22) Filed: Oct. 29, 2019

Related U.S. Application Data
(63) Continuation of application No. PCT/JP2018/007528, filed on Feb. 28, 2018.

(30) Foreign Application Priority Data
Jun. 7, 2017 (JP) 2017-112874

(51) Int. Cl. G06Q 30/02; G06Q 50/00

(52) U.S. Cl. CPC G06Q 30/0241; G06Q 50/01

(57) ABSTRACT

An information processing method executed by an information processing apparatus includes providing a social networking service including an instant messaging service, to an information processing terminal used by a user; and calculating a level of credit for a settlement of the user based on information on the user in the social networking service.

### CROSS-REFERENCE TO RELATED APPLICATIONS

This U.S. non-provisional application is a continuation application of, and claims the benefit of priority under 35 U.S.C. § 365(c) from, PCT International Application PCT/JP2018/007528 filed on Feb. 28, 2018, which designated the U.S., and is based upon and claims the benefit of priority of Japanese Patent Application No. 2017-112874 filed on Jun. 7, 2017, the entire contents both of which are incorporated herein by reference.

### TECHNICAL FIELD

The present disclosure relates to an information processing method, an information processing apparatus, and a recording medium having a program recorded.

### BACKGROUND ART

In recent years, so-called online shopping services (Internet shopping) that enable customers to purchase products and/or services online via the Internet and the like have become popular. In the online shopping, companies that sell products and/or services provide services such that points are given according to the purchased amount, and special discount sales are offered for specific customers (see, for example, Patent Document 1).

### PATENT DOCUMENTS

Patent Document 1: Japanese Laid-Open Patent Application No. 2003-256704

### SUMMARY

### Problem to be Solved

However, in the conventional technologies, for example, in the case where it is desired to give a predetermined benefit to a user who has a relatively high rate of successful completion of transactions because of relatively few cancellations or returns of purchases, if the purchase history of the user is not long enough, there has been a problem that it is relatively difficult to appropriately determine the level of credit of the user with respect to settlements of the user.

The present disclosure has been made in view of the above problems and has an object to provide an information processing method, an information processing apparatus, and a program that enable to determine a level of credit with respect to settlements of a user more appropriately.

According to an embodiment in the present disclosure, an information processing method executed by an information processing apparatus includes providing a social networking service including an instant messaging service, to an information processing terminal used by a user; and calculating a level of credit for a settlement of the user based on information on the user in the social networking service.

### BRIEF DESCRIPTION OF DRAWINGS

FIG. 1 is a diagram illustrating a configuration of a communication system according to an embodiment;

FIG. 2 is a diagram illustrating an example of a sequence of processing in a communication system according to an embodiment;

FIG. 3 is a diagram illustrating an example of a display screen for selecting a purchase site according to an embodiment;

FIG. 4 is a diagram illustrating an example of a display screen presenting a benefit according to a level of credit according to an embodiment;

FIG. 5 is a flow chart illustrating an example of a process for calculating the level of credit of a user in a server according to an embodiment;

FIG. 6 is a diagram illustrating an example of affiliated purchase history data according to an embodiment;

FIG. 7 is a diagram illustrating an example of purchase history data according to an embodiment;

FIG. 8 is a diagram illustrating an example of account data according to an embodiment; and

FIG. 9 is a diagram illustrating an example of settlement account data according to an embodiment.

### EMBODIMENTS

Embodiments for calculating a level of credit of a user according to the present disclosure will be described with reference to the drawings.

<System Configuration>

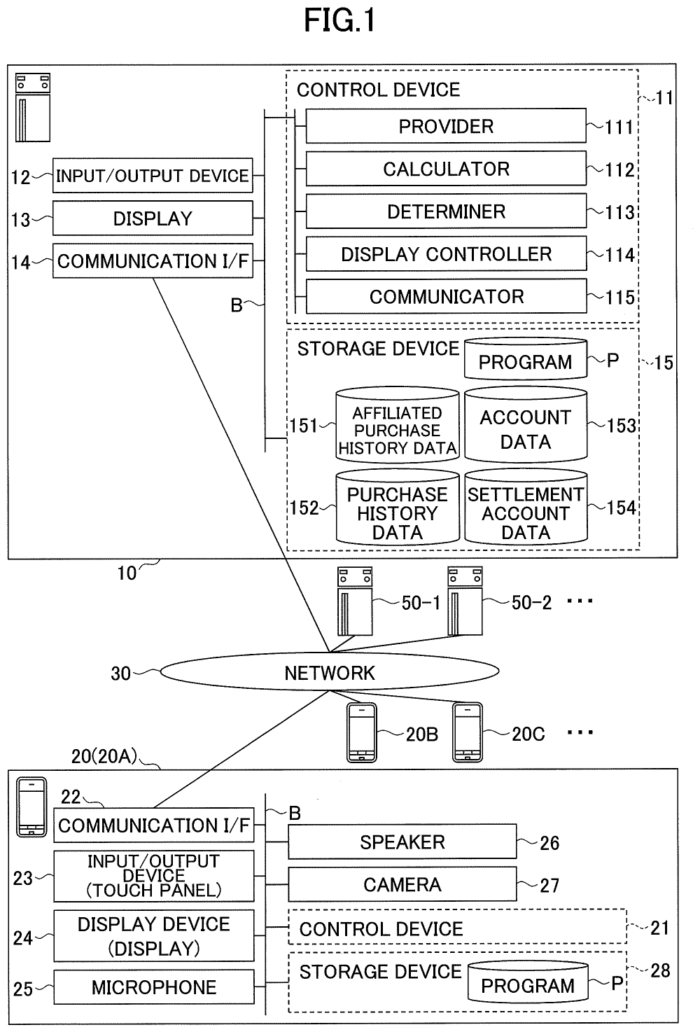

FIG. 1 is a diagram illustrating a configuration of a communication system according to an embodiment in the present disclosure. As illustrated in FIG. 1, in the communication system, a server 10, terminals 20 (terminal 20A, terminal 20B, and terminal 20C), and purchase servers 50-1, 50-2, and so on (referred to as the “purchase server 50” below, if the distinction is not necessary) are connected with each other via the network 30. Note that the purchase server 50 is an example of an “external server”. The server 10 provides the terminals 20 owned by users via the network 30 with a service of implementing transmission and reception of messages between the terminals 20. Note that the number of terminals 20 connected to the network 30 is not limited.

The network 30 plays a role of connecting one or more terminals 20 with one or more servers 10. In other words, the network 30 is a communication network that provides a connection path through which a terminal 20 can transmit and receive data after connecting to a server 10.

For example, one or more parts of the network 30 may be a wired network and/or a wireless network. The network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of a public switched telephone network (PSTN), a mobile phone network, integrated service digital networks (ISDNs), wireless LANs, long term evolution (LTE), code division multiple access (CDMA), Bluetooth (registered trademark), satellite communication, and a combination of two or more of these. However, in the present disclosure, the network 30 is not limited to these. Also, the network 30 may also include one or more networks.

The terminal 20 (terminal 20A, terminal 20B, or terminal 20C) may be any terminal as long as it can implement functions described in the embodiment. The terminal 20 is typically a smartphone and may also be a mobile phone (e.g., a feature phone), a computer (e.g., a desktop-type, a laptop-type, a tablet-type, and the like), a media computer platform (e.g., a cable/satellite TV set-top box, a digital video recorder, and the like), a handheld computing device (e.g., a PDA (personal digital assistant), an e-mail client, and the like), a wearable terminal (a glasses-type device, a watch-type device, and the like), or any other type of a computer or a communication platform. However, in the example embodiments, the terminal 20 is not limited to these. Also, the terminal 20 may be termed as an information processing terminal.

The configurations of the terminal 20A, the terminal 20B, and the terminal 20C are basically the same; therefore, in the following description, a representative terminal 20 will be described. Also, when necessary, user information associated with a terminal 20X will be referred to as user information X, and the user who operates the terminal 20X will be referred to as the user X in the description. Note that user information is a part or the entirety of information associated with an account in an SNS (Social Network Service) as represented by instant messaging, which includes, for example, a user name and a user image. Other information items may include a user identifier, user age, gender, address, and the like, and may be combinations of these. Note that the information items are not limited these.

The server 10 has functions of providing predetermined services to the terminals 20. The server 10 includes functions of providing, for example, an SNS; services of selling stamps and games usable on the SNS; and services of remittance and settlement. The server 10 also includes functions of providing, for example, a shopping mall service that presents information on affiliated shopping sites; and a point site service that gives points according to the purchased amount at the affiliated shopping sites. The server 10 also includes a function of calculating a level of credit related to settlements and the like of a user. Of course, separated servers 10 may be provided for the respective services described above.

The server 10 may be any type of information processing apparatus as long as it can implement functions described in the embodiments. The server 10 is typically a server device and may also be a computer (e.g., a desktop-type, a laptop-type, a tablet-type, and the like), a media computer platform (e.g., a cable/satellite TV set-top box, a digital video recorder, and the like), a handheld computing device (e.g., a PDA (personal digital assistant), an e-mail client, and the like), or any other type of a computer or a communication platform. Note that in the present disclosure, the server 10 is not limited to these. Also, the server 10 may be termed as an information processing apparatus.

The purchase server 50 is a server device that provides, for example, a web site for users to purchased products and/or services.

Note that the server 10 may be operated by, for example, a company that provides services such as an SNS. The purchase server 50 may be operated by, for example, a company that sells products and/or services such as clothing, food, cosmetics, financial products, and the like.

Also, the server 10 and the purchase server 50 may be configured as an integrated server.

<Hardware (HW) Configuration>

With reference to FIG. 1, a HW configuration of each device included in the communication system will be described.

(1) HW Configuration of Terminal

The terminal 20 includes a control device (CPU: Central Processing Unit) 21, a storage device 28, a communication I/F (interface) 22, an input/output device 23, a display device 24, a microphone 25, a speaker 26, and a camera 27. These elements of the HW of the terminal 20 are connected to each other, for example, via a bus B.

The communication I/F 22 transmits and receives various items of data via the network 30. The communication may be executed by wire and/or by radio, and any communication protocol may be used as long as mutual communication can be executed. The communication I/F 22 has a function of performing communication with the server 10 via the network 30. The communication I/F 22 transmits various items of data to the server 10 according to a command from the control device 21. Also, the communication I/F 22 receives various items of data transmitted from the server 10 and transfers the received data to the control device 21.

The input/output device 23 includes a device for inputting various operations on the terminal 20 and a device for outputting processed results processed on the terminal 20. The input/output device 23 may have the input device and the output device integrated, or have the input device and the output device separated.

The input device is implemented by any one of all types of devices or a combination of these devices that can receive input from the user and can transmit information related to the input to the control device 21. The input device is typically implemented by a touch panel or the like, to detect contact by a pointer, such as a finger of the user or a stylus, and the contact position, and to transmit the coordinates of the contact position to the control device 21. Meanwhile, the input device may be implemented by an input device other than the touch panel. The input device includes, for example, hardware keys represented by a keyboard or the like, a pointing device such as a mouse, a camera (operation input via moving images), and a microphone (operation input by voice). However, the input device is not limited to these in the present disclosure.

The output device is implemented by any one or a combination of all types of devices capable of outputting processed results processed by the control device 21. The output device is typically implemented by a touch panel or the like. Meanwhile, the output device may be implemented by an output device other than a touch panel. For example, a speaker (audio output), a lens (e.g., 3D (three dimensional) output or hologram output), a printer, and the like may be included. However, the output device is not limited to these in the present disclosure.

The display device 24 is implemented by any one of all types of devices or a combination of these that can execute displaying according to display data written in a frame buffer. The display device 24 is typically implemented by a monitor (e.g., a liquid crystal display or an GELD (organic electroluminescence display)). The display device 24 may be a head-mounted display (HMD). Also, the display device 24 may be implemented by projection mapping, hologram, or a device that is capable of displaying images, text information, and the like in the air or the like (which may be a vacuum). Note that the display device 24 may be capable of displaying display data in 3D. However, the display device 24 is not limited to these in the present disclosure.

In the case where the input/output device 23 is a touch panel, the input/output device 23 and the display device 24 may have substantially the same size and shape to be arranged to face each other.

The control device 21 has a circuit that is physically structured to execute functions implemented by codes or instructions included in a program, and is implemented by, for example, a data processing device built in the hardware.

The control device 21 is typically a central processing unit (CPU), and also may be a microprocessor, a processor core, multiprocessors, an ASIC (application-specific integrated circuit), or an FPGA (field-programmable gate array). However, the control device 21 is not limited to these in the present disclosure.

The storage device 28 has a function of storing various programs and various items of data required when the terminal 20 operates. The storage device 28 is implemented by various storage media such as an HDD (hard disk drive), an SSD (solid state drive), a flash memory, a RAM (random access memory), a ROM (read-only memory), and the like. However, the storage device 28 is not limited to these in the present disclosure.

In the terminal 20, a program P is stored in the storage device 28, and the control device 21 running this program P executes processes corresponding to respective functional units included in the control device 21. In other words, the program P stored in the storage device 28 implements the functions executed by the control device 21 on the terminal 20.

The microphone 25 is used for inputting audio data. The speaker 26 is used for outputting audio data. The camera 27 is used for obtaining data of moving images.

(2) HW Configuration of Server

The server 10 includes a control device (CPU) 11, a storage device 15, a communication I/F (interface) 14, an input/output device 12, and a display 13. These elements of the HW of the server 10 are mutually connected, for example, via a bus B.

The control device 11 has a circuit that is physically structured to execute functions implemented by codes or instructions included in a program, and is implemented by, for example, a data processing device built in the hardware.

The control device 11 is typically a central processing unit (CPU), and may be a microprocessor, a processor core, multiprocessors, an ASIC, or an FPGA. However, in the present disclosure, the control device 11 is not limited to these in the present disclosure.

The storage device 15 has a function of storing various programs and various items of data required for the server 10 to operate. The storage device 15 is implemented by various storage media such as an HDD, an SSD, a flash memory, and the like. However, the storage device 15 is not limited to these.

The communication I/F 14 transmits and receives various items of data via the network 30. The communication may be executed by wire or by radio, and any communication protocol may be used as long as mutual communication can be executed. The communication I/F 14 has a function of executing communication with the terminal 20 via the network 30. The communication I/F 14 transmits various items of data to the terminal 20 according to an instruction from the control device 11. Also, the communication I/F 14 receives various items of data transmitted from the terminal 20, and transmits the data to the control device 11.

The input/output device 12 is implemented by a device that inputs various operations on the server 10. The input/output device 12 is implemented by any one of all types of devices or a combination of these devices that can receive input from the user and can transmit information related to the input to the control device 11. The input/output device 12 is typically implemented by hardware keys represented by a keyboard or the like, a pointing device such as a mouse, and the like. Note that the input/output device 12 may include, for example, a touch panel, a camera (operation input via moving images), and a microphone (operation input by voice). However, the input/output device 12 is not limited to these in the present disclosure.

The display 13 is typically implemented by a monitor (e.g., a liquid crystal display or an GELD (organic electroluminescence display)). Note that the display 13 may be a head-mounted display (HMD) or the like. Note that the display 13 may be capable of displaying display data in 3D. However, the display 13 is not limited to these.

In the server 10, the program P is stored in the storage device 15, and the control device 11 running this program P executes processes corresponding to respective functional units included in the control device 11. In other words, the program P stored in the storage device 15 implements the functions executed by the control device 11 on the server 10.

Each embodiment in the present disclosure will be described assuming that it is implemented by the CPU(s) of the terminal 20 and/or the server 10 executing the program P.

The control device 21 of the terminal 20 and/or the control device 11 of the server 10 may be implemented not only by a CPU but also by a logic circuit (hardware) or a dedicated circuit formed in an integrated circuit (IC) chip, an LSI (Large Scale Integration) chip, or the like. Also, these circuits may be implemented by one or more integrated circuits, and multiple processes described in the embodiment may be implemented by a single integrated circuit. Also, an LSI may also be referred to as a VLSI, a super LSI, an ultra LSI, or the like depending on the degree of integration.

Also, the program P (software program/computer program) in the present disclosure may be provided in a state stored in a computer-readable recording medium. The recording medium can store the program in a “non-transitory tangible medium”.

When appropriate, the recording medium may include one or more semiconductor-based or other integrated circuits (ICs) such as field-programmable gate arrays (FPGAs) or application-specific integrated circuits (ASICs); a hard disk drive (HDD), a hybrid hard drive (HHD), an optical disk, an optical disk drive (ODD), a magneto-optical disk, a magneto-optical drive, a floppy diskette, a floppy disk drive (FDD), a magnetic tape, a solid state drive (SSD), a RAM drive, a secure digital card or drive, any other suitable recording medium, or any suitable combination of two or more of these. When appropriate, the recording medium may be volatile, non-volatile, or may have a combination of volatility and non-volatility. Note that the recording medium is not limited to these examples, and may be any device or medium as long as it can store the program P.

The server 10 and/or the terminal 20 can read the program P, for example, stored in the recording medium and execute the read program P to realize the functions of multiple functional units described in each embodiment.

Also, the program P in the present disclosure may be provided to the server 10 or the terminal 20 via any transmission medium (a communication network, a broadcasting wave, or the like) capable of transmitting the program. The server 10 and/or the terminal 20 realize functions of multiple functional units described in the respective example embodiments by executing the program P downloaded via, for example, the Internet or the like.

Each embodiment in the present disclosure can also be implemented in a form of a data signal embedded in a carrier wave in which the program P is embodied by electronic transmission. At least part of the processing on the server 10 and/or terminals 20 may be implemented by cloud computing constituted with one or more computers.

At least part of the processing on the terminal 20 may be performed by the server 10. In this case, for example, the server 10 may be configured to perform at least part of processing among the processing executed by the functional units of the control device 21 of the terminal 20.

At least part of the processing on the server 10 may be performed on the terminal 20. In this case, for example, the terminal 20 may be configured to perform at least part of processing among the processing executed by the functional units of the control device 11 of the server 10.

In the present disclosure, a determination is not configured to be mandatory, and it is obvious that predetermined processing may be performed if the determination condition is satisfied or predetermined processing may be performed if the determination condition is not satisfied.

Note that the program in the present disclosure can be implemented by using a script language such as ActionScript, JavaScript (registered trademark), and the like; an object-oriented programming language such as Objective-C, Java (registered trademark), and the like; and a markup language such as HTML5 and the like. However, the program is not limited to be implemented by these languages. However, the present disclosure is not limited to these.

The present embodiment calculates a level of credit of a user for providing benefits to the user depending on the period of use of the SNS account and friends in the SNS. This enables to determine the level of credit with respect to settlements of the user more appropriately. Therefore, for example, it is possible to provide a service such that depending on the level of credit of the user, the timing of giving a benefit is brought forward.

<Functional Configuration>

As illustrated in FIG. 1, the server 10 includes, as functional units implemented by the control device 11, a provider 111, a calculator 112, a determiner 113, a display controller 114, and a communicator 115.

The provider 111 provides the terminals 20 with services such as an SNS including an instant messaging service, services of selling stamps and games usable on the SNS, remittance and settlement services usable on the SNS, and the like. The provider 111 also provides the terminals 20 with various services such as a shopping mall service that presents information on affiliated shopping sites, and a point site service that gives points according to the purchased amount at the affiliated shopping sites. The provider 111 also provides the terminal 20 with a benefit according to a level of credit as determined by the determiner 113.

The calculator 112 calculates a level of credit with respect to settlements of the user of the terminal 20 in the SNS or the like provided by the provider 111.

The determiner 113 determines various benefits to be given to the user of the terminal 20 depending on the level of credit calculated by the calculator 112.

The display controller 114 controls displaying on the screen on the terminal 20 according to processes executed by the provider 111, the determiner 113, and the like.

The communicator 115 communicates with the terminal 20 and the purchase server 50. The communicator 115 may transmit, for example, information on benefits depending on the calculated level of credit to the terminal 20.

The storage device 15 stores various items of data such as affiliated purchase history data 151, purchase history data 152, account data 153, and settlement account data 154.

<Process>

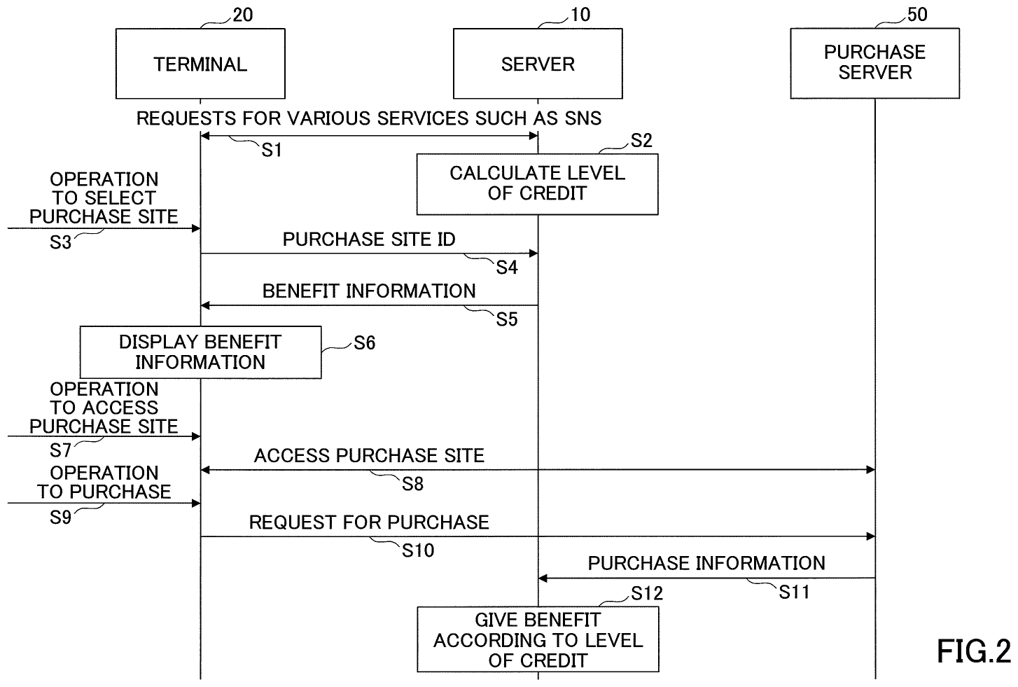

Next, with reference to FIG. 2, processing in the communication system according to an embodiment will be described. FIG. 2 is a diagram illustrating an example of a sequence of processing in the communication system according to the embodiment.

At Step S1, the terminal 20 accesses the server 10 by using, for example, a predetermined application or a web browser, to use various services such as an SNS.

Next, at Step S2, the calculator 112 of the server 10 calculates the level of credit of the user of the terminal 20. Note that a process of calculating the level of credit will be described later.

Next, at Step S3, the terminal 20 receives an operation from the user to select, for example, a predetermined purchase site on the screen displayed by the display controller 114 of the server 10.

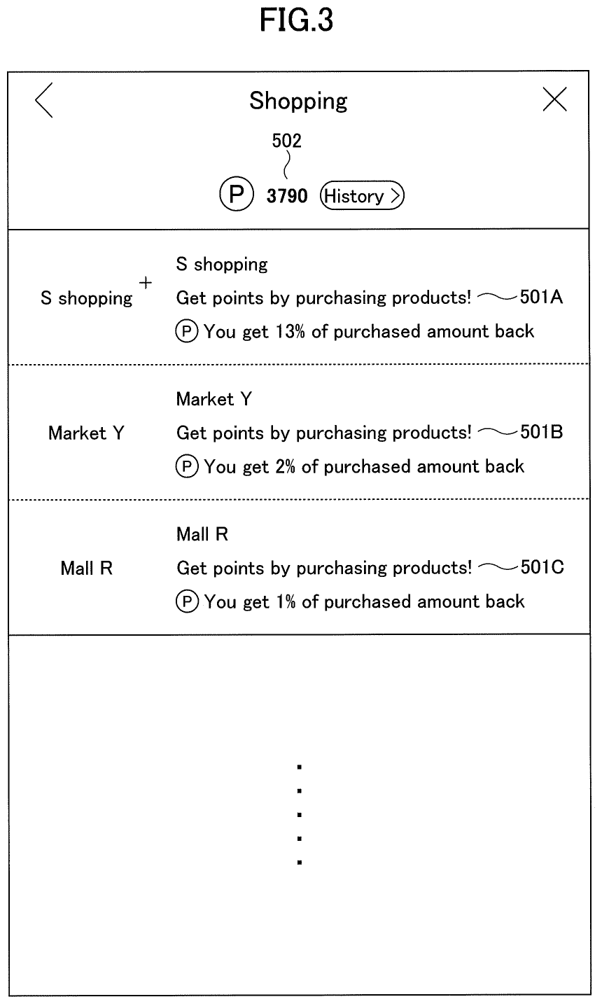

FIG. 3 is a diagram illustrating an example of the display screen for selecting a purchase site. In the example in FIG. 3, a list of, for example, purchase sites 501A, 501B, 501C, and so on of respective companies affiliated with the company operating the server 10 is displayed on the screen of the terminal 20. Also, in a predetermined area 502 on the screen, points already given to the user of the terminal 20 is displayed. Note that the points may be set to be usable, for example, for payment for contents such as stamps usable on the SNS service provided on the server 10 or for products and the like on the purchase server 50.

Next, at Step S4, the terminal 20 transmits information on the selected purchase site to the server 10. Here, the information on the purchase site may include, for example, an ID of the purchase site selected by the user.

Next, at Step S5, the communicator 115 of the server 10 transmits benefit information according to the calculated level of credit to the terminal 20. Here, the server 10 may classify the level of credit into three stages (classes) in descending order of the level of credit, for example, “good”, “normal”, and “bad (default)”. In this case, the server 10 may provide a benefit according to the level of credit, for example, as a period of time to give points such that a “good” user will be given the points on the next day after an approval for purchase (authorization) by the operating company of the purchase server 50. Also, the server 10 may set the period for a “normal” user as 30 days after the completion of a purchase or the like, and for a “bad” user as 70 days after the completion of a purchase or the like, or 25th day of the month after the next or later.

Next, at Step S6, the terminal 20 displays the received benefit information to the user.

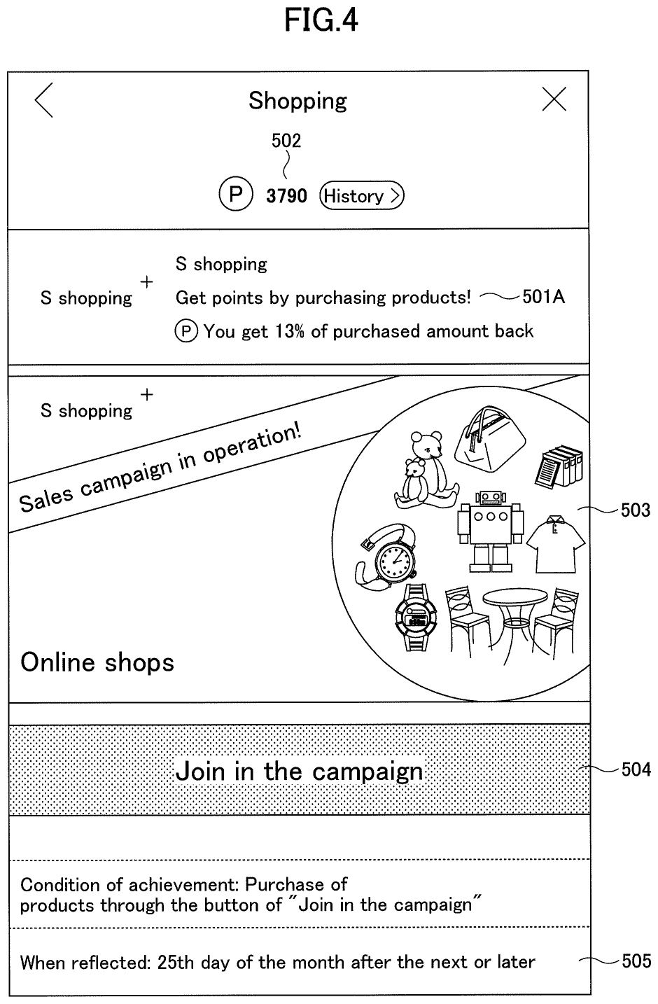

FIG. 4 is a diagram illustrating an example of a display screen of a benefit according to a level of credit. FIG. 4 illustrates an example of the display screen on the terminal 20 when the purchase site 501A illustrated in FIG. 3 is selected. In the example in FIG. 4, an area 503 displays, for example, an advertisement of the purchase site 501A; and an area 505 displays, as benefit information according to the level of credit, the timing of giving points as a predetermined proportion of a purchased amount, which is set on the 25th day of the month after the next or later.

Next, at Step S7, the terminal 20 receives an operation to connect to (access) a purchase site from the user. Here, for example, the terminal 20 may receive an operation of pressing a button 504 by the user on the display screen illustrated in FIG. 4.

Next, at Step S8, the terminal 20 accesses the purchase site on the purchase server 50 selected by the user. The purchase site may be, for example, a shopping site on the Web.

Next, at Step S9, the terminal 20 receives an operation from the user to purchase a product or the like at the purchase site.

Next, at Step S10, in response to the operation by the user, the terminal 20 transmits a request for purchasing the product or the like to the purchase server 50. Here, the terminal 20 receives operations from the user such as selection of a desired product, selection of a payment method, and input of a delivery address, and transmits the received contents to the purchase server 50. This step completes the operations performed by the user for purchasing the product or the like.

Next, at Step S11, the purchase server 50 transmits the purchase information from the user of the terminal 20 to the server 10. Here, the purchase information includes the user ID for identifying the user, the purchased amount, and the purchase server ID. The user ID may be, for example, an ID of the terminal 20, a telephone number of the terminal 20, an account ID of the user for the SNS on the server 10, or the like. The purchase server ID may be, for example, an ID of the purchase server 50 or an ID of the company operating the purchase server 50. Note that the server 10 may receive the purchase information directly from the purchase server 50, or may receive, for example, through another server (a talk server, settlement server, e-commerce server, etc.) operated by the company operating the server 10.

Next, at Step S12, the provider 111 of the server 10 provides the user with a benefit according to the level of credit of the user. Here, the purchase server 50 gives points to the account of the user at the timing of giving the points determined, for example, according to the level of credit.

Of course, depending on the type of benefit, the benefit information may not be transmitted to the terminal 20 by omitting Step S5 and Step S6. As a non-limiting example, if the benefit is given as a period of time to give points according to the purchased amount, the server 10 may execute processing internally to provide the benefit without displaying the benefit information on the terminal 20. In other words, the period of time to give the points is not displayed on terminal 20, and the period of time to give the points may be set according to the level of credit.

### First Modified Example

In the above description, an example has been described in which the timing of giving points is determined as a benefit according to the level of credit.

The determiner 113 of the server 10 may determine as a benefit according to the level of credit, for example, a rate of points with respect to the purchased amount (rate of returning points). In this case, for example, for a good user having a relatively high level of credit, the rate of returning points may be set high. This provides, for example, a motivation to a user who is presumed to have made relatively few cancellations, returns, mischief, and the like, to purchase a greater number of products; relatively low necessity of making allowance for expenses due to handling of cancellations and the like allows such a benefit.

The determiner 113 of the server 10 may also determine, for example, viewable or purchasable products as a benefit according to a level of credit. In this case, for example, a good user having a relatively high level of credit may be provided with information on sites of inventory clearance sales of finished products for which cancellation and return are restricted.

<<Calculation of Level of Credit>>

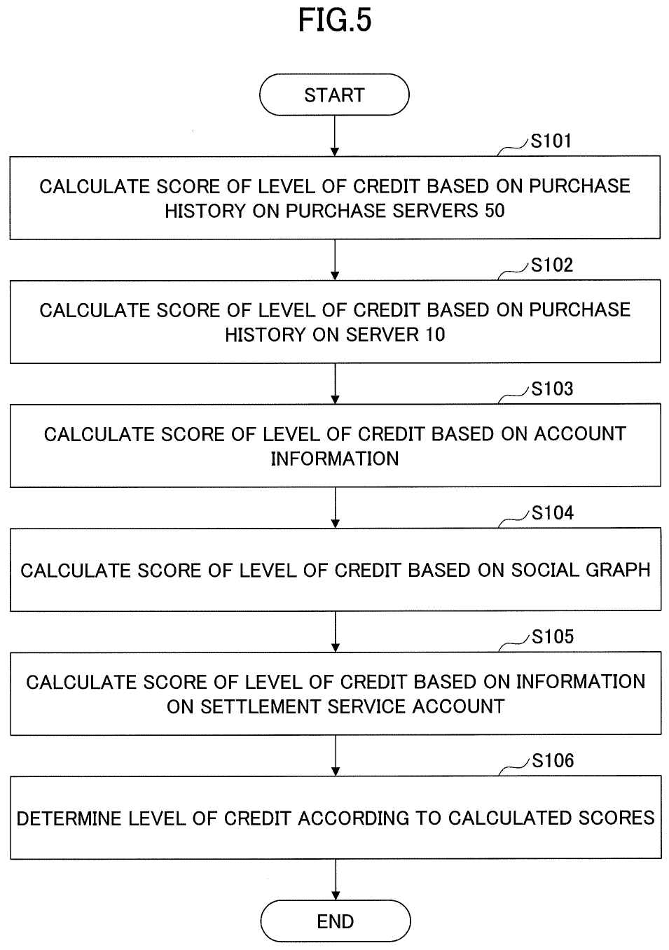

Next, with reference to FIG. 5, a process of calculating the level of credit of a user in the calculator 112 of the server 10 at Step S6 in FIG. 2 will be described. FIG. 5 is a flow chart illustrating an example of a process of calculating the level of credit of a user in the server 10. Note that in the following, a user whose level of credit is to be calculated is also referred to as the “user being processed”.

At Step S101, the calculator 112 refers to the affiliated purchase history data 151, to calculate a score on the level of credit based on the purchase history of the user being processed on the purchase servers 50.

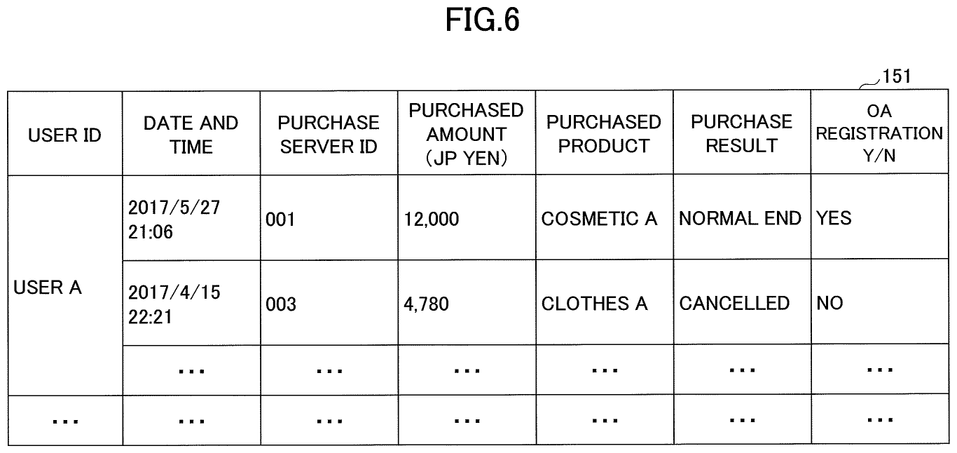

FIG. 6 is a diagram illustrating an example of the affiliated purchase history data 151. The affiliated purchase history data 151 records, for example, the purchase history of each user on the purchase servers 50 of companies affiliated with the company operating the server 10. The affiliated purchase history data 151 illustrated in FIG. 6 records dates and times, purchase server IDs, purchased amounts, purchased products, purchase results, and YES or NO of OA registrations, which are associated with the respective user IDs. The date and time is, for example, a date and time when a purchase procedure on the purchase server 50 was completed by the user. The purchased amount is a price of a product or the like for which a purchase procedure was completed. The purchased product is an ID, type, or name of the product for which the purchase procedure was completed. The purchase result is information representing a final purchase result, which may include “canceled”, “return”, and “normal completion”. “Canceled” indicates that the purchase procedure was canceled prior to shipment of the product. “Return” indicates that the product was returned after the product had been shipped. “Normal completion” indicates that payment was completed for the product; the product or the like was received; and the purchase was settled.

The item of YES or NO of OA registration represents information indicating whether or not the user registers the account related to a purchase server ID (an official account (OA)) as a friend, follower, or the like in the SNS service provided on the server 10. Note that registering the account related to a purchase server ID as a friend or the like enables to receive messages such as a coupon from the account.

Here, the calculator 112 refers to the affiliated purchase history data 151, to calculate the purchase frequency of the user being processed. The purchase frequency may be calculated by dividing, for example, a period of time from the first recorded date and time in the purchase history of the user being processed up to the current date and time, by the number of purchased items in the purchase history of the user being processed. Of course, the period of time may be set to any period of time.

The calculator 112 also calculates the rate and the number of times of “cancellation” and “return” (other than “normal completion”). Note that the rate of “cancellation” and “return” may be calculated, for example, for the user being processed, by dividing the number of data items whose purchase results are “cancellation” and “return” by the number of all data items whose purchase results are “cancellation”, “return”, and “normal completion”.

Then, the calculator 112 calculates a higher score of the level of credit for a higher purchase frequency. The calculator 112 also calculates a higher score of the level of credit for a smaller rate and a smaller number of times of “cancellation” and “return”. The calculator 112 also calculates a relatively high score of the level of credit if the OA registration is “YES”.

Next, at Step S102, the calculator 112 refers to the purchase history data 152, to calculate a score of the level of credit based on the purchase history of the user being processed on the server 10.

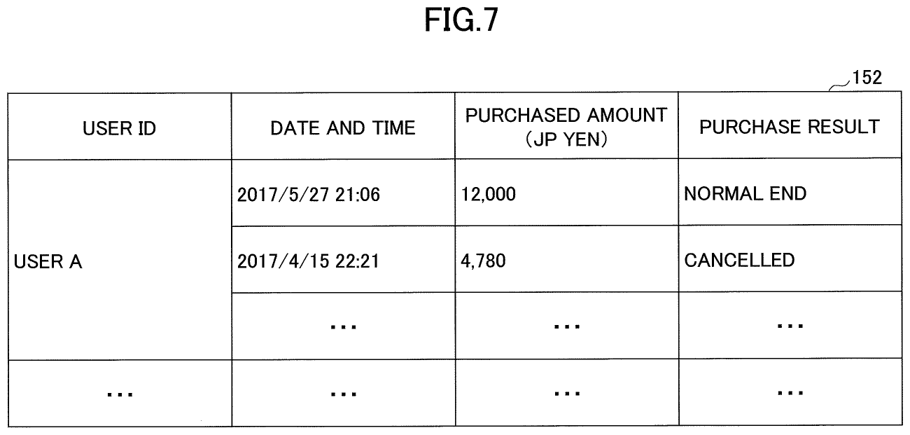

FIG. 7 is a diagram illustrating an example of the purchase history data 152. The purchase history data 152 records, for example, the purchase history of each user on the server 10. The purchase history data 152 illustrated in FIG. 7 records dates and times, purchased amounts, purchased products, purchase results, and the like, which are associated with the respective user IDs. Note that the provider 111 of the server 10 may sell, for example, contents such as stamps, games, music, cartoons, and the like usable on the SNS. Then, the calculator 112 calculates a higher score of the level of credit, for example, for a user whose purchase frequency is higher.

Next, at Step S103, the calculator 112 refers to the account data 153, to calculate a score of the level of credit based on information on the account of the user being processed.

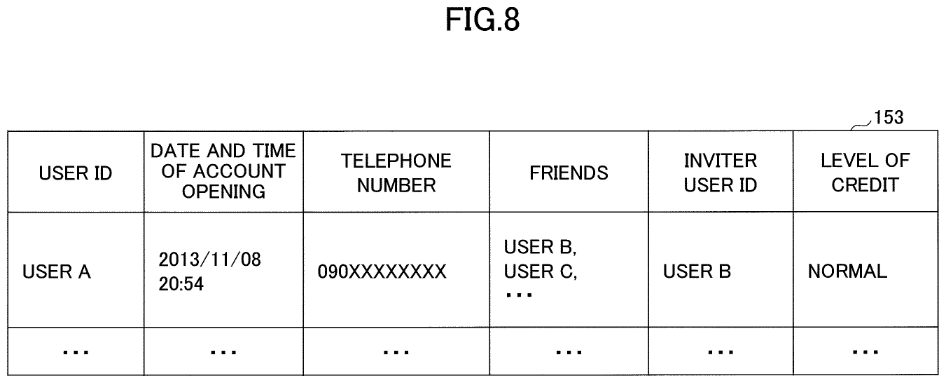

FIG. 8 is a diagram illustrating an example of the account data 153. The account data 153 records, for example, information on the account in the SNS service provided by the provider 111. The account data 153 illustrated in FIG. 8 records account-opened dates and times, telephone numbers, and the like, which are associated with the respective user IDs. The account-opened date and time is a date and time when the account was newly created on the server 10 by the user being processed. The telephone number is a telephone number of a smartphone or the like that corresponds to the terminal 20 or the like of the user being processed. Note that the telephone number may be confirmed in advance as a telephone number currently used by the user being processed by using, for example, an SMS (Short Message Service) or the like of a mobile phone company (carrier). Also, before obtaining the telephone number, personal authentication may be performed with respect to the user by the mobile phone company.

Here, the calculator 112 refers to the account data 153, to calculate an account use period, which is a period from the account-opened date and time to the current date and time. Then, the server 10 calculates a higher score of the level of credit for a longer account use period. Also, the server 10 calculates a relatively high score of the level of credit if the telephone number is registered for the account of the user.

Next, at Step S104, the calculator 112 refers to the account data 153, to calculate a score of the level of credit based on a social graph of the user being processed. The account data 153 illustrated in FIG. 8 further records friends, inviting user IDs, levels of credit, and the like, which are associated with the respective user IDs. The friend is a user ID of another user registered as a friend (friend, acquaintance) by the user specified in the field of “user ID” in the SNS service provided on the server 10. The inviting user ID is a user ID of a user who invited the user specified in the field of “user ID” to a predetermined service (e.g., a shopping service) using the SNS provided on the server 10. Note that when an inviting user introduced a friend to the predetermined service in the SNS provided on the server 10, in order to increase the number of users, the company that provides the predetermined service may, for example, give predetermined points to the inviting user and the friend as the invited user. The level of credit is a level of credit for each user ID calculated previously.

Here, the calculator 112 refers to the account data 153, to calculate the number of other users registered as the friends by the user being processed, the number of other users who register the user being processed as the friend, and the number of other users who register the user being processed as the friend and are registered as the friends of the user being processed.

Then, the calculator 112 calculates a higher score of the level of credit for a greater number of other users registered as the friends by the user being processed, a greater number of other users who register the user being processed as the friend, and a greater number of other users who register the user being processed as the friend and are registered as the friends of the user being processed.

Also, the server 10 refers to the account data 153, to extract the levels of credit of the other users registered as the friends by the user being processed, the levels of credit of the other users who register the user being processed as the friend, and the levels of credit of the other users who register the user being processed as the friend and are registered as the friends of the user being processed.

Then, the calculator 112 calculates the score of the level of credit based on the levels of credit of the other users registered as the friends by the user being processed, the levels of credit of the other users who register the user being processed as the friend, and the levels of credit of the other users who register the user being processed as the friend and are registered as the friends of the user being processed. In this case, the server 10 may calculate a higher score of the level of credit, for example, for a higher mean, median, maximum, or minimum value of the level of credit of each of the other users.

The calculator 112 also calculates a higher score of the level of credit for a higher level of credit of the inviting user ID. Thus, the level of credit of a user invited by a user having a high level of credit is calculated relatively higher.

Next, at Step S105, the calculator 112 refers to the settlement account data 154, to calculate a score of the level of credit based on information regarding the settlement service account of the user being processed.

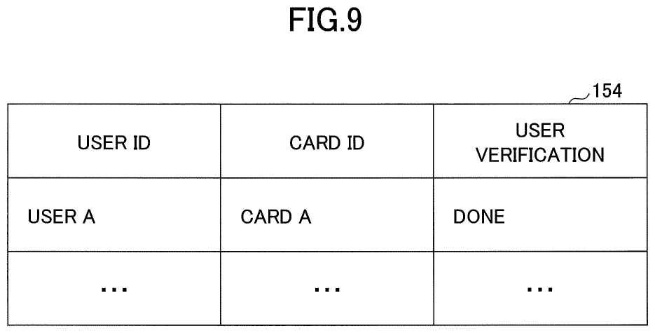

FIG. 9 is a diagram illustrating an example of the settlement account data 154. The settlement account data 154 records, for example, information on accounts in the settlement service provided on the server 10. The settlement account data 154 illustrated in FIG. 9 records card IDs and user verification results, which are associated with the respective user IDs. The card ID is, for example, an ID of a credit card or the like used for settlement. The user verification is information representing whether the user has been verified, for example, by using an official identification document such as the resident card, driver's licenses, or insurance certificate. Note that, for example, in the case where a card related to the card ID is used as a prepaid card, user verification may not be performed.

Here, the calculator 112 refers to the settlement account data 154, to calculate a relatively high score of the level of credit when the user being processed has an account in the settlement service and the user verification has been performed.

Next, at Step S106, the calculator 112 determines the level of credit according to the calculated scores of the level of credit.

The server 10 may calculate the level of credit as a weighted sum of the scores of the items at Step S101 to Step S105, which are multiplied by weight coefficients set in advance for the respective items. Alternatively, the server 10 may determine the level of credit based on the mean, median, total, or maximum values of the scores calculated for the respective items. Of course, the level of credit may be determined by any single item or any combination of the items obtained at Step S101 to Step S105.

A user who aims to illegally obtain benefits such as points (referred to as a “malicious user”, below) may have characteristics including that it has not been long since the account was opened (a relatively short period of use); that few SNS friends are registered; and that little information on the user is registered. According to the present embodiment, the level of credit to such a malicious user can be calculated low.

### Second Modified Example

When calculating the score of the level of credit based on a social graph of the user at Step S104, the calculator 112 may use, in addition to the information on the SNS account on the server 10, information on another SNS service account associated with the account. In this case, based on the period of use, number of friends, personal information, and the like with respect to the account of the other SNS service, the score of the level of credit may be calculated higher, for example, if the period of use is longer, if the number of friends is greater, and/or if the number or amount of data items entered as the personal information is greater.

### Third Modified Example

The provider 111 of the server 10 may issue a notification to the purchase server 50 of information on the level of credit. In this case, the notification of the information on the level of credit may be issued to the purchase server 50, for example, at regular intervals. Alternatively, when the purchase server 50 is accessed from a terminal 20 of a user to perform a transaction that requires the information on the level of credit, the purchase server 50 may obtain the account ID, password, and the like on the server 10 from the terminal 20, so as to obtain the information on the level of credit from the server 10.

In this case, the purchase server 50 may issue a notification to the terminal 20, for example, of the rate of returning points on the purchase server 50 according to the level of credit. Note that the points may be set usable at the purchase site of the purchase server 50 or at a real store operated by the operating company of the purchase server 50. Also, the purchase server 50 may issue a notification to the terminal 20 of predetermined products and the like according to the level of credit. Such a notification may provide product information to the terminals 20, such as inventory clearance sales of finished products for which cancellation and return are not allowed, for example, only for users with a relatively high level of credit. Alternatively, information on limited products having higher rates of returning points on the server 10 may be provided to the terminal 20.

### Fourth Modified Example

When calculating a score of the level of credit based on the social graph at Step S104, the calculator 112 may perform processing as follows.

In the case where the user being processed uses the instant messaging service provided on the server 10, calculate a higher score of the level of credit for a greater number of messages or a greater amount of data transmitted to the other users.

In the case where the user being processed uses the instant messaging service provided on the server 10, calculate a higher score of the level of credit for a greater number of messages or a greater amount of data received from the other users.

Conventionally, in online shopping, it has been known that when a user purchases a product or the like, the user is given a benefit, for example, a predetermined proportion of points relative to the purchased amount. Note that the points may be used, for example, in subsequent purchases.

Here, if the benefit is given when the product is purchased, when the payment is made, or when the product is delivered, in the case where the user takes an action of, for example, canceling the purchase, returning the purchased product, or notifying an incorrect address as the delivery destination of the product, time and effort may be required for canceling the benefit that has been given already. Meanwhile, if delaying the timing of giving the benefit comparatively, although time and effort may be reduced for canceling a benefit that would have been given already, there is a problem that the timing of receiving the benefit by the user is also delayed.

According to the present disclosure, a level of credit is calculated for giving a benefit to a user according to the period of use of an SNS account and friends in the SNS. This enables to provide services in which, for example, the timing of giving the benefit can be expedited according to the level of credit of the user. This also enables, for example, compared to a case where the level of credit is calculated based only on the purchase history or the like of the user, to calculate the level of credit more precisely for a user who purchases a product for the first time or for a user who makes purchases less frequently.

The present disclosure has been described with reference to the drawings and embodiments. Note that a person skilled in the art can easily make various transformations and modifications based on the present disclosure. Therefore, note that transformations and modifications are within the scope of the present inventive concept. For example, the functions or the like included in functional units, steps, and the like are relocatable as long as not introducing logical contradiction, and multiple functional units, steps, and the like can be combined into one entity, or can be further divided. Also, the elements described in the respective embodiments may be appropriately combined.

What is claimed is:

1. An information processing method executed by an information processing apparatus, the method comprising:
providing a social networking service including an instant messaging service, to an information processing terminal used by a user; and
calculating a level of credit for a settlement of the user based on information on the user in the social networking service.

2. The information processing method as claimed in claim 1, wherein the calculating of the level of credit is based on at least one of a period of use and presence or absence of a registered telephone number with respect to the account of the user in the social networking service.

3. The information processing method as claimed in claim 1, wherein the calculating of the level of credit calculates the level of credit based on at least one of a number of other users registered as friends by the user, a number of other users who register the user as a friend, and a number of other users who register the user as a friend and are registered as friends of the user.

4. The information processing method of claim 1, wherein the calculating of the level of credit calculates the level of credit based on at least one of levels of credit of other users registered as friends by the user, levels of credit of other users who register the user as a friend, levels of credit of other users who register the user as a friend and are registered as friends of the user, and a level of credit of an inviting user who invited the user to a predetermined service associated with the social networking service.

5. The information processing method as claimed in claim 1, further comprising:
calculating a period of time to give points according to the level of credit, the points being usable upon receiving a predetermined service; and
giving the user the points according to a purchased amount at a shopping site at a timing when the period of time will have elapsed.

6. An information processing apparatus comprising:
a memory; and
a processor configured to execute providing a social networking service including an instant messaging service, to an information processing terminal used by a user; and
calculating a level of credit for a settlement of the user based on information on the user in the social networking service.

7. A non-transitory computer-readable recording medium having computer-readable instructions stored thereon, which when executed, cause a computer that includes a memory and a processor, to execute a method comprising:
providing a social networking service including an instant messaging service, to an information processing terminal used by a user; and
calculating a level of credit for a settlement of the user based on information on the user in the social networking service.
